(19) United States
(12) Patent Application Publication
(10) Pub. No.: US 2025/0060283 A1
(43) Pub. Date: Feb. 20, 2025

(54) LEVELING CONTROL SYSTEM FOR ACCELERATION TESTER

(71) Applicant: AGENCY FOR DEFENSE DEVELOPMENT, Daejeon (KR)

(72) Inventors: Hyun Myung Kim, Daejeon (KR); HYUK BEOM KWON, Daejeon (KR)

(73) Assignee: AGENCY FOR DEFENSE DEVELOPMENT, Daejeon (KR)

(21) Appl. No.: 18/800,319

(22) Filed: Aug. 12, 2024

(30) Foreign Application Priority Data
Aug. 14, 2023 (KR) 10-2023-0106046

(51) Int. Cl. G01M 99/00

(52) U.S. Cl. CPC G01M 99/004

(57) ABSTRACT

A leveling control system for an acceleration tester includes a support portion installed on a ground, a level portion of which a center is connected to one side of the support portion, a test portion located on one side of the level portion and configured to accommodate a test body, and a control portion located on an other side of the level portion, wherein the control portion includes guide rails formed extending in a longitudinal direction of the level portion and a first weight configured to move along the guide rails.

### CROSS-REFERENCE TO RELATED APPLICATION

This application claims the benefit of Korean Patent Application No. 10-2023-0106046 filed on Aug. 14, 2023, in the Korean Intellectual Property Office, the entire disclosure of which is incorporated herein by reference for all purposes BACKGROUND

### FIELD OF THE INVENTION

One or more embodiments relate to a leveling control system for an acceleration tester.

### DESCRIPTION OF THE RELATED ART

A centrifugal acceleration tester for environmental testing may create moment equilibrium to keep the centrifugal acceleration tester leveled by installing a test body and a dummy object at either ends of symmetrical arms of test equipment. When an imbalance of vertical moment occurs during a centrifugal acceleration test, it may cause a serious accident such as loss of life or damage to the test equipment, so the moment equilibrium is an important factor in designing centrifugal acceleration test equipment. Typical centrifugal acceleration test equipment may only be tested once a dummy object having a same weight as that of a test body is prepared. However, manufacturing a test dummy object to be used only for an acceleration test for each test subject may result in unnecessary waste of time and cost. In addition, manufacturing a dummy object to be of the same weight as that of a test body is difficult, and there have been cases of actual acceleration tests in which a small weight difference between a dummy object and a test body created an imbalance of horizontal moment, resulting in a delay in tests and a risk of accidents. Another inconvenience is that, since a test table on which a test body is to be installed is fixed, the test body needs to be removed from the test table and a test axis needs to be adjusted in order to change a direction of a test axis of the test body. To solve these issues, the present disclosure proposes applying a leveling control system to a dummy weight installation location of an acceleration tester and applying a test axis conversion system to a test body installation table to allow efficient and safe acceleration testing.

Registration Patent No. 10-1936963 discloses information regarding a balance maintaining apparatus.

### SUMMARY

Embodiments provide a leveling control system for an acceleration tester capable of performing a test without a dummy object having a weight equal to a weight of a test body when performing an acceleration test using a centrifugal acceleration tester.

Embodiments provide a leveling control system for an acceleration tester capable of reducing a risk of personal injury and damage to a test body due to an operating error by changing a test axis without removing the test body from a plate.

According to an aspect, there is provided a leveling control system for an acceleration tester including a support portion installed on a ground, a level portion of which a center is connected to one side of the support portion, a test portion located on one side of the level portion and configured to accommodate a test body, and a control portion located on an other side of the level portion, wherein the control portion includes guide rails formed extending in a longitudinal direction of the level portion and a first weight configured to move along the guide rails.

The first weight may be configured to move along the guide rails so that the test portion and the control portion may be controlled to be horizontal.

The guide rails may include a first guide rail formed extending from a central part of the control portion and two second guide rails, each of which may extend from either side of the first guide rail and may be disposed on either side of the first guide rail, and the first weight may include a first hole formed in a central part of the first weight and through which the first guide rail may pass, two second holes formed on either side of the central part of the first weight and through which each of the two second guide rails may pass, and a brake pad that may be located on a side of the first weight on which the second holes may be located and that may be configured to fix the first weight.

The first guide rail may have a spiral rod shape and may include a rotating component connected to the first guide rail and configured to move the first weight by rotating the first guide rail, and the second guide rails may have a cylindrical shape.

The leveling control system for an acceleration tester may further include a plurality of second weights detachably attached to the first weight.

The first weight may include a plurality of fastening grooves formed spaced apart from each other at determined intervals in an upper surface of the first weight, and the second weights may be configured to be fixed to the first weight as a fastening component may be configured to penetrate the second weights and to be inserted into the fastening grooves.

Positions of the first weight and the second weights moved by the control portion may be determined according to Equation 1,

$$x = \frac{M}{m + {m}^{′}} L \qquad [ Equation 1 ]$$

wherein x may denote a distance from the side of the support portion 100 to the first weight 500, M may denote a mass of the test body, m may denote a mass of the first weight, m′ may denote a mass of the second weights, and L may denote a distance from the side of the support portion to the test body.

The first weight and the second weights may be fixed on positions determined according to Equation 1.

The test portion may include a plate on which the test body may be placed and a hinge configured to connect the plate to the level portion.

The plate may be configured to rotate with respect to the level portion through the hinge.

The plate may include a plurality of through holes formed spaced apart from each other at determined intervals, and the test body may be fixed to the plate as a fastener may be configured to penetrate a fixture on which the test body may be installed and to be inserted into the through holes.

A rotating portion may be located on one side of the support portion, the rotating portion may be connected to the level portion, and as the rotating portion rotates, the level portion may be configured to rotate about an axis perpendicular to the ground.

Additional aspects of embodiments will be set forth in part in the description which follows and, in part, will be apparent from the description, or may be learned by practice of the disclosure.

According to embodiments, a leveling control system for an acceleration tester may perform a test without a dummy object having a weight equal to a weight of a test body when performing an acceleration test using a centrifugal acceleration tester.

According to embodiments, a leveling control system for an acceleration tester may reduce a risk of personal injury and damage to a test body due to an operating error by changing a test axis without removing the test body from a plate.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an overall structure of a leveling control system for an acceleration tester, according to an embodiment;

FIG. 2 is a diagram illustrating a specific structure of a control portion of a leveling control system for an acceleration tester, according to an embodiment;

FIG. 3 is a diagram illustrating a cross-sectional view of a first weight, according to an embodiment;

FIG. 4 is a diagram illustrating a structure in which a second weight is added to a first weight, according to an embodiment;

FIG. 5 is a diagram illustrating a specific structure of a test portion of a leveling control system for an acceleration tester, according to an embodiment; and

FIG. 6 is a diagram illustrating a structure in which a test axis of a test portion is changed, according to an embodiment

### DETAILED DESCRIPTION

Hereinafter, embodiments are described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not intended to be limiting. The singular forms “a,” “an,” and “the” are intended to include the plural forms as well, unless the context clearly indicates otherwise. It should be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical or scientific terms used herein have the same meaning as those commonly understood by one of ordinary skill in the art to which the embodiments belong. Terms, such as those defined in commonly used dictionaries, are to be interpreted as having a meaning that is consistent with their meaning in the context of the relevant art and the present disclosure and are not to be interpreted in an idealized or overly formal sense unless expressly so defined herein.

When describing the embodiments with reference to the accompanying drawings, like reference numerals refer to like components and a repeated description related thereto is omitted. In the description of embodiments, detailed description of well-known related structures or functions is omitted when it is deemed that such description may cause ambiguous interpretation of the present disclosure.

In addition, in the description of the components of the embodiments, terms such as first, second, A, B, (a), (b), and the like may be used. These terms are used only for the purpose of discriminating one component from another component, and the nature, the sequences, the orders, or the like of the components are not limited by the terms. It is to be understood that if a component is described as being “connected,” “coupled,” or “joined” to another component, the former may be directly “connected,” “coupled,” or “joined” to the latter or “connected,” “coupled,” or “joined” to the latter via another component.

The same name may be used to describe components having a common function in different embodiments. Unless otherwise mentioned, the description of one embodiment may be applicable to other embodiments. Thus, duplicated description is omitted for conciseness.

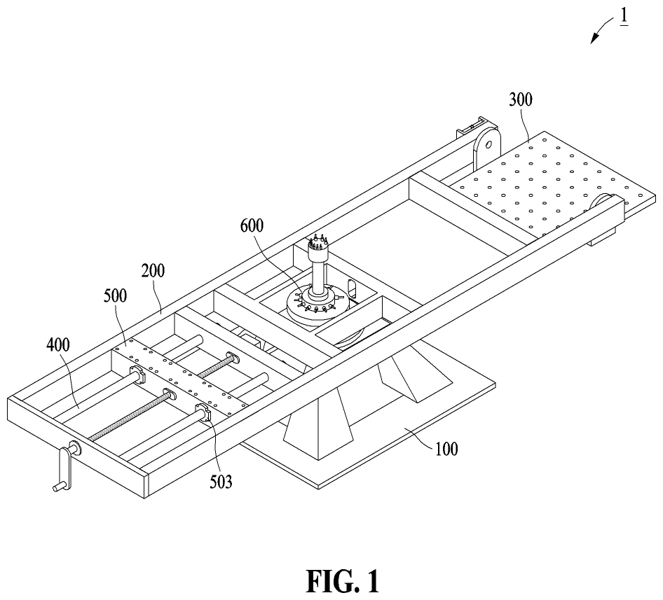

FIG. 1 is a diagram illustrating an overall structure of a leveling control system 1 for an acceleration tester, according to an embodiment.

Referring to FIG. 1, the leveling control system 1 for an acceleration tester may include a support portion 100 installed on a ground, a level portion 200 of which a center is connected to one side of the support portion 100, a test portion 300 located on one side of the level portion 200 and configured to accommodate a test body (not shown), and a control portion 400 located on an other side of the level portion 200. The control portion 400 may include guide rails (e.g., a first guide rail 410 and two second guide rails 420) formed extending in a longitudinal direction of the level portion 200 and a first weight 500 configured to move along the guide rails.

That is, the support portion 100 may function as a supporting point, and the first weight 500 may move along the guide rails so that the test portion 300 located on one side of the level portion 200 and the control portion 400 located on the other side of the level portion 200 may achieve a moment equilibrium.

Specifically, a test body (not shown) may be installed on the test portion 300 located on one side of the level portion 200, the first weight 500 and the guide rails may be installed on the control portion 400 located on the other side of the level portion 200, and the first weight 500 may move along the guide rails so that the level portion 200 may be placed parallel to the ground. That is, a mechanical engineering principle of the leveling control system 1 for an acceleration tester may be based on the moment equilibrium.

A rotating portion 600 may be located on one side of the support portion 100 and may be connected to the level portion 200. As the rotating portion 600 rotates, the level portion 200 may rotate about an axis perpendicular to the ground. That is, an acceleration test may be performed as the level portion 200 is rotated by the rotating portion 600 in a state in which the test portion 300 and the control portion 400 are in the moment equilibrium.

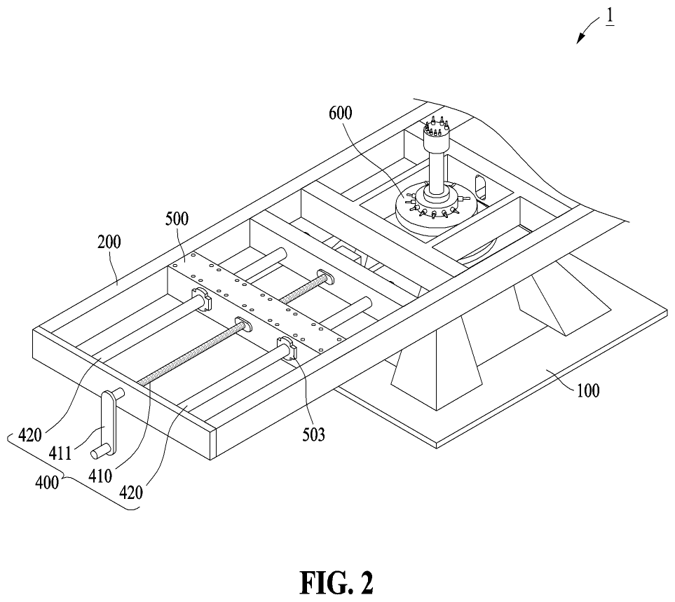

FIG. 2 is a diagram illustrating a specific structure of the control portion 400 of the leveling control system 1 for an acceleration tester, according to an embodiment.

The first weight 500 may move along test portion 300 and the control portion 400 may be controlled to be horizontal by the first weight 500 moving along the guide rails.

The guide rails may include the first guide rail 410 formed extending from a central part of the control portion 400 and the two second guide rails 420, which may each extend from either side of the first guide rail 410 and be disposed on either side of the first guide rail 410.

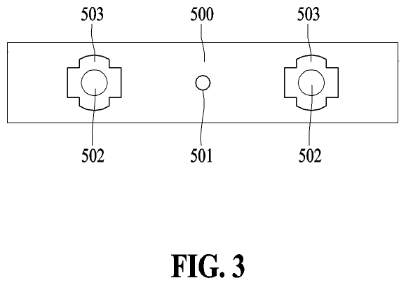

FIG. 3 is a diagram illustrating a cross-sectional view of the first weight 500, according to an embodiment.

The first weight 500 may include a first hole 501 formed in a central part of the first weight 500 and through which the first guide rail 410 may pass, two second holes 502 formed on either side of the central part of the first weight 500 and through which each of the two second guide rails 420 may pass, and a brake pad 503 that may be located on a side of the first weight 500 on which the second holes 502 are located and may fix the first weight 500.

The first guide rail 410 may have a spiral rod shape and may include a rotating component 411 that may be connected to the first guide rail 410 and may move the first weight 500 by rotating the first guide rail 410. In addition, the two second guide rails 420 may have a cylindrical shape.

Specifically, a spiral of the first guide rail 410 and a spiral inside the first hole 501 of the first weight 500 may be connected to each other and the first guide rail 410 may be rotated clockwise or counterclockwise by the rotating component 411 so that the first weight 500 may move. In addition, the first weight 500 may be fixed by the brake pad 503 when the first weight 500 is located in a position on which the moment equilibrium between the test portion 300 and the control portion 400 is achieved. The first weight 500 may be fixed by screws located on either side of the brake pad 503.

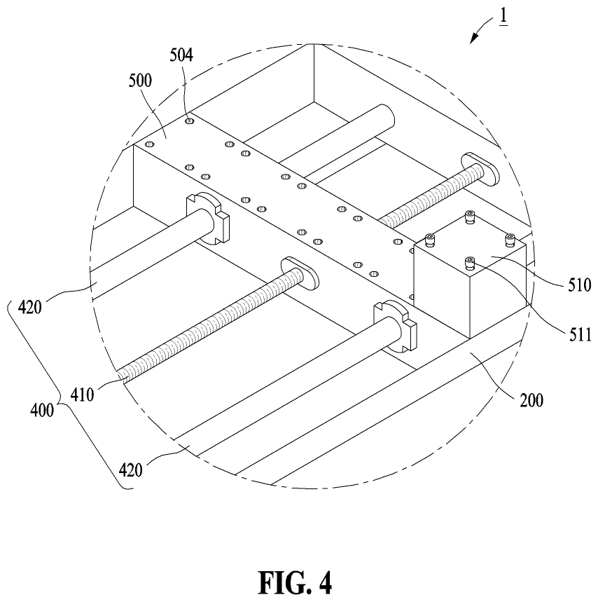

FIG. 4 is a diagram illustrating a structure in which a second weight 510 is added to the first weight 500, according to an embodiment.

The leveling control system 1 for an acceleration tester may further include a plurality of second weights 510 that may be detachably attached to the first weight 500. For example, the first weight 500 may correspond to 180 kg, and each of the second weights 510 may correspond to 20 kg. A number of the second weights 510 may be up to 6. In this case, a sum of masses of the first weight 500 and the second weights 510 may be in a range from 180 kg to 300 kg, and as a result, a mass of the test body (not shown) may be in a range from 20 kg to 300 kg. That is, when the first weight 500 corresponds to a 300 kg weight formed as a single weight, a test body (not shown) of at least 60 kg may be needed to achieve horizontality between the test portion 300 and the control portion 400, due to a limited length of the level portion 200. Accordingly, there may be a limitation in that a test body (not shown) of less than 60 kg may not be tested. Thus, a range of a mass of a testable test body (not shown) may be expanded by adding the plurality of second weights 510 to the first weight 500 so that the test body (not shown) of less than 60 kg may also be tested.

In addition, the first weight 500 may include a plurality of fastening grooves 504 formed spaced apart from each other at determined intervals in an upper surface of the first weight 500, and the second weights 510 may be fixed to the first weight 500 as a fastening component 511 may penetrate the second weights 510 and be inserted into the fastening grooves 504.

The fastening component 511 may correspond to, for example, a high strength bolt, and the second weight 510 may be installed on the upper surface of the first weight 500 and may remain in a stably fixed state without being separated from the upper surface of the first weight 500 even in an acceleration environment of up to 980 m/s².

Positions of the first weight 500 and the second weights 510 moved by the control portion 400 may be determined according to Equation 1 below based on the moment equilibrium.

$$x = \frac{M}{m + {m}^{′}} L \qquad [ Equation 1 ]$$

Here, in Equation 1, x denotes a distance from one side of the support portion 100 to the first weight 500, M denotes a mass of a test body (not shown), m denotes the mass of the first weight 500, m′ denotes the mass of the second weights 510, and L denotes a distance from the side of the support portion 100 to the test body (not shown).

Equation 1 may be derived from Equation 2, which corresponds to a moment equilibrium equation.

$$( m + {m}^{′} ) gx = MgL \qquad [ Equation 2 ]$$

Here, in Equation 2, x denotes the distance from the side of the support portion 100 to the first weight 500, g denotes gravitational acceleration, M denotes the mass of the test body (not shown), m denotes the mass of the first weight 500, m′ denotes the mass of the second weights 510, and L denotes the distance from the side of the support portion 100 to the test body (not shown).

The first weight 500 and the second weights 510 may be fixed on positions determined according to Equation 1.

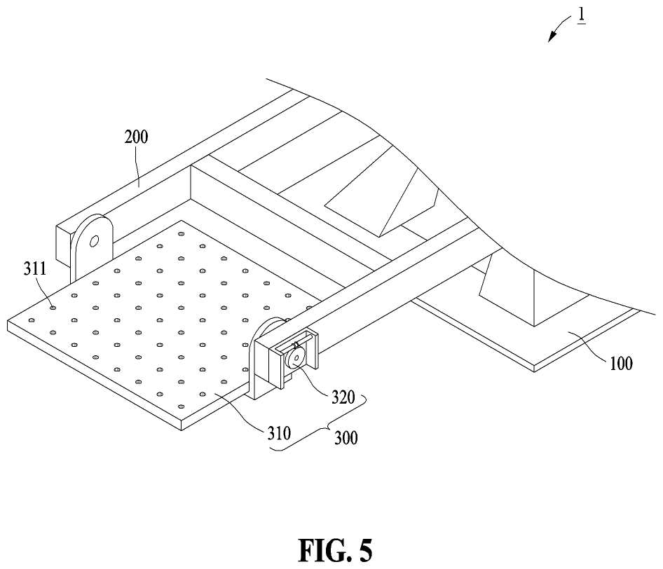

FIG. 5 is a diagram illustrating a specific structure of the test portion 300 of the leveling control system 1 for an acceleration tester, according to an embodiment.

As shown in FIG. 5, the test portion 300 may include a plate 310 on which a test body (not shown) may be placed and a hinge 320 connecting the plate 310 to the level portion 200.

The plate 310 may include a plurality of through holes 311 formed spaced apart from each other at determined intervals, and the test body (not shown) may be fixed to the plate 310 as a fastener (not shown) may penetrate a fixture (not shown) on which the test body (not shown) may be installed and be inserted into the through holes 311.

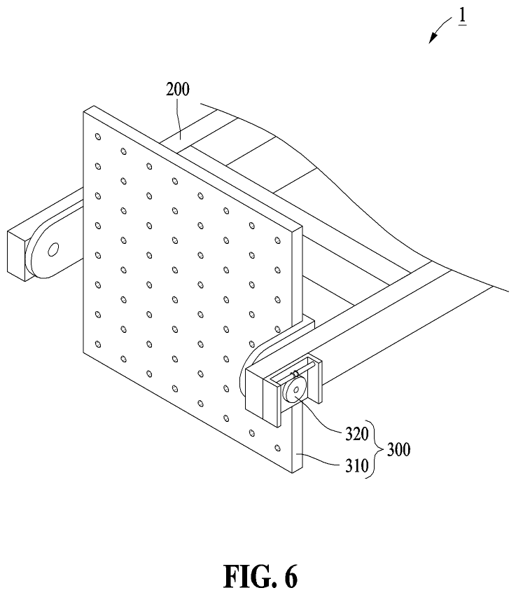

FIG. 6 is a diagram illustrating a structure in which a test axis of the test portion 300 is changed, according to an embodiment.

As shown in FIG. 6, the plate 310 may rotate with respect to the level portion 200 through the hinge 320. That is, by allowing the plate 310 to rotate, the test axis may be changed without removing a test body (not shown) fixed to the plate 310.

Specifically, in the case of an acceleration test, the acceleration test may need to be performed for each axis of three-dimensional coordinate axes based on a test body. A conventional acceleration tester has the plate 310 of a fixed type and thus has a difficulty of having to remove the test body (not shown) from the plate 310 when changing the test axis. The leveling control system 1 for an acceleration tester according to the present disclosure may change the test axis without removing the test body (not shown) from the plate 310 since the plate 310 may rotate. Thus, a risk of personal injury and damage to the test body due to an operating error when changing the test axis may be prevented.

As the description above, the leveling control system 1 for an acceleration tester may perform a test without a dummy object having a weight equal to a weight of a test body when performing an acceleration test using a centrifugal acceleration tester.

In addition, the leveling control system 1 for an acceleration tester may reduce a risk of personal injury and damage to a test body due to an operating error by changing a test axis without removing the test body from the plate 310.

Although the embodiments have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A leveling control system for an acceleration tester comprising:
a support portion installed on a ground;
a level portion of which a center is connected to one side of the support portion;
a test portion located on one side of the level portion and configured to accommodate a test body; and
a control portion located on an other side of the level portion,
wherein the control portion comprises:
guide rails formed extending in a longitudinal direction of the level portion; and
a first weight configured to move along the guide rails.

2. The leveling control system for an acceleration tester of claim 1, wherein the first weight is configured to move along the guide rails so that the test portion and the control portion are controlled to be horizontal.

3. The leveling control system for an acceleration tester of claim 2, wherein
the guide rails comprise:
a first guide rail formed extending from a central part of the control portion; and
two second guide rails, each of which extends from either side of the first guide rail and is disposed on either side of the first guide rail, and
the first weight comprises:
a first hole formed in a central part of the first weight and through which the first guide rail is configured to pass;
two second holes formed on either side of the central part of the first weight and through which each of the two second guide rails is configured to pass; and
a brake pad located on a side of the first weight on which the second holes are located and configured to fix the first weight.

4. The leveling control system for an acceleration tester of claim 3, wherein
the first guide rail has a spiral rod shape and comprises a rotating component connected to the first guide rail and configured to move the first weight by rotating the first guide rail, and the second guide rails have a cylindrical shape.

5. The leveling control system for an acceleration tester of claim 4, further comprising: a plurality of second weights detachably attached to the first weight.

6. The leveling control system for an acceleration tester of claim 5, wherein
the first weight comprises a plurality of fastening grooves formed spaced apart from each other at determined intervals in an upper surface of the first weight, and
the second weights are configured to be fixed to the first weight as a fastening component penetrates the second weights and is inserted into the fastening grooves.

7. The leveling control system for an acceleration tester of claim 6, wherein positions of the first weight and the second weights moved by the control portion are determined according to Equation 1 below,
$$x = \frac{M}{m + {m}^{′}} L \qquad [ Equation 1 ]$$
wherein x denotes a distance from the side of the support portion 100 to the first weight 500, M denotes a mass of the test body, m denotes a mass of the first weight, m denotes a mass of the second weights, and L denotes a distance from the side of the support portion to the test body.

8. The leveling control system for an acceleration tester of claim 7, wherein the first weight and the second weights are fixed on positions determined according to Equation 1.

9. The leveling control system for an acceleration tester of claim 8, wherein the test portion comprises:
a plate on which the test body is placed; and
a hinge configured to connect the plate to the level portion.

10. The leveling control system for an acceleration tester of claim 9, wherein the plate is configured to rotate with respect to the level portion through the hinge.

11. The leveling control system for an acceleration tester of claim 10, wherein
the plate comprises a plurality of through holes formed spaced apart from each other at determined intervals, and
the test body is fixed to the plate as a fastener penetrates a fixture on which the test body is installed and is inserted into the through holes.

12. The leveling control system for an acceleration tester of claim 11, wherein
a rotating portion is located on one side of the support portion,
the rotating portion is connected to the level portion, and
as the rotating portion rotates, the level portion is configured to rotate about an axis perpendicular to the ground.
